(19) United States
(12) Patent Application Publication
(10) Pub. No.: US 2006/0035044 A1
(43) Pub. Date: Feb. 16, 2006

(54) Multi-layered medical container and medical plural chamber container

(76) Inventors: Kenji Omori, Osaka-shi (JP); Minoru Honda, Osaka-shi (JP); Makoto Iwaike, Osaka-shi (JP); Masashi Moteki, Osaka-shi (JP)

Correspondence Address: KUBOVCIK & KUBOVCIK, SUITE 710, 900 17TH STREET NW, WASHINGTON, DC, 20006, US

(21) Appl. No.: 11/203,286

(22) Filed: Aug. 15, 2005

(30) Foreign Application Priority Data
Aug. 16, 2004 (JP) 2004-236395

(51) Int. Cl. B32B 27/08

(52) U.S. Cl. 428/35.7

(57) ABSTRACT

A multi-layered medical container formed by a multi-layered film, in which an innermost layer is a layer comprising a cyclic polyolefin or a polymer blend containing the cyclic polyolefin, and a layer, which is adhered to the above-described layer, having a linear polyolefin or polyamide is provided. Also, a multi-layered medical plural chamber container which includes a body divided by a peelable seal portion into a medical liquid-containing chamber that stores the medical liquid and a medicament-containing chamber that stores the medicament is provided.

### BACKGROUND OF THE INVENTION

The present invention relates to a multi-layered medical container and a multi-layered medical plural chamber container and, in particular, relates to a multi-layered medical container and multi-layered medical plural chamber container which suppress elution of components from the container and from an adhesion layer.

Conventionally, as a container for storing a medicament, a container which is formed from a linear polyolefin monolayer film or a multi-layered film containing the linear polyolefin layer, a polymer having a moisture or a gas barrier property, has been widely used. Further, in recent years, an application of the multi-layered film in which these films are bonded with each other by an adhesion has been approved in a medical field by a revised Japan Pharmacopoeia, and, thus, medical containers with a number of properties have been developed. Accordingly, it has become possible to contain various types of medicaments in such containers.

However, owing to enhancement of properties of the container and capability of containing various types of medicaments, such problems as a decrease of medicament content, an increase of an analogous substance, an increase of turbidity of a medicinal liquid and an increase of an insoluble particulate are caused by an interaction between impurities such as a low molecular weight component eluted from the linear polyolefin or a component eluted from the adhesion layer; and the medicament which is an active ingredient.

Under these circumstances, various types of plastic products have been proposed as materials for medical use in which a container is not deformed by sterilization, the medicament is not denatured by eluting of an impurity or absorbing of an active ingredient and transparency is not deteriorated by steam sterilization.

Among these products, a thermoplastic norbornene resin, that is, a cyclic polyolefin, is used as a raw material for medical products (JP-A 4-276253, JP-A 6-255053, JP-A 7-266517, JP-A 10-59345, U.S. Pat. No. 6,042,906 and JP-A 2002-301796).

As for the medical containers, although containers subjected to a high-pressure sterilization or a high-temperature sterilization such as a hot-water sterilization are described in the prior art, it has not been studied whether these containers can be irradiated by γ-rays. Further, it has not yet been studied whether plural chamber containers can be subjected to γ-ray sterilization, in which a solid medicament and a liquid medicament are respectively stored and both of them are mixed with each other at the time of being used. Particularly, in the plural chamber container, when an objective medicament is prepared from the solid medicament, which has been stored for a long time, and the medical liquid, it is important to study an alteration of the medicament, a change of turbidity of the thus-prepared medicament, an appearance change of the container by sterilization with γ-ray irradiation, and the like.

The object of the present invention is to provide a multi-layered medical container and a multi-layered medical plural chamber container, which mainly use a cyclic polyolefin and are capable of being subjected to a γ-ray sterilization, while reducing a low molecular weight component and an adhesion layer component eluted from the multi-layered container, and thus, to solve problems, for example, a decrease of a medicament content, an increase of an analogous substance, an increase of turbidity of a medicament and an increase of an insoluble particulate generated by an interaction between these components and the medicament. The containers further show medicament stability.

### SUMMARY OF THE INVENTION

The present invention relates to a multi-layered medical container comprising a body and a port, the body being formed by a multi-layered film having a layer comprising a cyclic polyolefin or a polymer blend containing the cyclic polyolefin and a layer, adhered to the former layer, comprising a linear polyolefin or a polyamide.

The present invention further relates to a multi-layered medical plural chamber container comprising a body and a discharge port, the body being divided by a peelable seal portion in a fluid-tight manner into a medical liquid-containing chamber that stores a medical liquid and a medicament-containing chamber that stores a medicament, wherein the medicament-containing chamber is a bag-shape article constituted by a front sheet and a rear sheet, and wherein the front sheet and/or the rear sheet are constituted by a multi-layered film having a layer comprising a cyclic polyolefin or a polymer blend containing the cyclic polyolefin and a layer, adhered to the former layer, comprising a linear polyolefin or a polyamide.

The present invention further relates to a multi-layered medical plural chamber container comprising a body and a discharge port, the body being divided by a peelable seal portion in a fluid-tight manner into a medical liquid-containing chamber that stores a medical liquid and a medicament-containing chamber that stores a medicament, wherein the medicament-containing chamber is a bag-shape article constituted by a front sheet and a rear sheet wherein the front sheet of the medicament-containing chamber is constituted by a multi-layered film in which (i) a layer comprising a cyclic polyolefin or a polymer blend containing the cyclic polyolefin, (ii) a layer, which is adhered to the layer (i), comprising a linear polyolefin or a polyamide, (iii) a polyester layer or a polyester layer comprising an inorganic-material deposited thin film and (iv) a linear polyolefin layer are laminated in this order.

The present invention still further relates to a multi-layered medical plural chamber container comprising a body and a discharge port, the body being divided by a peelable seal portion in a fluid-tight manner into a medical liquid-containing chamber that stores a medical liquid and a medicament-containing chamber that stores a medicament, wherein the medicament-containing chamber is a bag-shape article constituted by a front sheet and a rear sheet wherein the rear sheet of the medicament-containing chamber is constituted by a multi-layered film in which (i) a layer comprising a cyclic polyolefin or a polymer blend containing the cyclic polyolefin, (ii) a layer, which is adhered to the layer (i), comprising a linear polyolefin or a polyamide, (v) a metal foil, a metal deposited layer or an inorganic-material deposited layer and (vi) a polyester layer are laminated in this order.

The present invention even still further relates to a multi-layered medical plural chamber container comprising a body and a discharge port, the body being divided into a medical liquid-containing chamber that stores a medical liquid and a medicament-containing chamber that stores a medicament by a peelable seal portion in a fluid-tight manner, wherein the medicament-containing chamber is a bag-shape article constituted by a front sheet and a rear sheet wherein the front sheet of the medicament-containing chamber is constituted by a multi-layered film in which (i) a layer comprising a cyclic polyolefin or a polymer blend containing the cyclic polyolefin, (ii) a layer, which is adhered to the layer (i), comprising a linear polyolefin or a polyamide, (iii) a polyester layer or a polyester layer comprising an inorganic-material deposited thin film and (iv) a linear polyolefin layer are laminated in order and the rear sheet of the medicament-containing chamber is constituted by a multi-layered film in which (i) a layer comprising a cyclic polyolefin or a polymer blend containing the cyclic polyolefin, (ii) a layer, which is adhered to the layer (i), comprising a linear polyolefin or a polyamide, (v) a metal foil, a metal deposited layer or an inorganic-material deposited layer and (vi) a polyester layer are laminated in this order.

In the present invention, elution of a component with a low molecular weight and of an adhesion component from these multi-layered containers is reduced by allowing a multi-layered film having a layer comprising a cyclic polyolefin or a polymer blend containing the cyclic polyolefin and a layer, adhered to the former layer, comprising a linear polyolefin or a polyamide to be a material of a container and, further, by allowing the layer comprising the cyclic polyolefin to be an innermost layer. Further, such problems as a decrease of a medicament content, an increase of an analogous substance, an increase of turbidity in the medicament and an increase of an insoluble particulates caused by an interaction with these components and the medicament are solved and, thus, it becomes possible to provide a multi-layered medical container showing medicament stability. Moreover, in the present invention, there is an effect such that a γ-ray sterilization can be performed in place of a steam sterilization and, still further, in the plural chamber container, when an objective medicament is prepared from a solid medicament stored for a long time period and a medical liquid, it becomes possible to reduce an alteration of the medicament, a change of the turbidity in the thus-prepared medicament, an appearance change of the container by the γ-ray sterilization and the like.

Even still further, in the present invention, because the multi-layer comprises the cyclic polyolefin as an innermost layer, it becomes possible to form a weak seal portion by thermally bonding the medicament-containing chamber and the medical liquid-containing chamber with each other and, then, at the time of use, to peel the weak seal portion and allow the medicament and the medical liquid to be mixed with each other to obtain an objective medicament and, thereafter, to discharge the thus-obtained medicament from the discharge port.

### BRIEF DESCRIPTION OF THE DRAWINGS

FIG. 1 is a cross-sectional view showing a multi-layered plural chamber container of the invention.

FIG. 2 is front elevational view showing a multi-layered plural chamber container of the invention.

FIG. 3 is a cross-sectional view showing a multi-layered film (front sheet) constituting a multi-layered container of the invention.

FIG. 4 is a cross-sectional view showing a multi-layered film (rear sheet) constituting a multi-layered container of the invention.

### DETAILED DESCRIPTION OF THE INVENTION

In the present invention, the term “multi-layered medical container” as used herein means a multi-layered container which has a plurality of layers of films or sheets (hereinafter, referred to also as “film” inclusive of sheet), can have various types of shapes such as a bag-shape article, a bottle, a tube, a cell and a pre-filled syringe and can contain one or more medicaments. At least one layer among the plural films comprises a cyclic polyolefin or a polymer blend containing the cyclic polyolefin as a substrate.

Further, in the present invention, the term “multi-layered medical plural chamber container” as used herein means a container which has one or more chambers that stores medical liquids and one or more chambers that stores medicaments and, then, at the time of an application, allows the medical liquid or liquids and the medicament or medicaments to be mixed with each other to obtain a blended medicament. The multi-layered medical plural chamber container is a container formed with one type or a plurality of films which are similar to those in the multi-layered medical container, and can have various shapes such as a bag-shape article, a bottle and a pre-filled syringe. Also, at least one layer among the plural films comprises a cyclic polyolefin or a polymer blend containing the cyclic polyolefin as a substrate.

In the multi-layered container, in accordance with purposes of application, a discharge port such as a medicament outlet portion is provided in one of the chambers.

In the present invention, the term “gas barrier layer” as used herein means a layer which has a property to block passage of moisture or a gas. Further, in the present invention, the term “printable layer” as used herein means a layer which can be printed by a medium such as a printing ink when a letter or a picture is shown on a container surface.

In the present invention, the term “easy-peel function” as used herein means a function capable of easily peeling at the time of medicament preparation a laminated portion of films which form the container and are bonded with each other.

In the present invention, the term “adhesion layer” as used herein means a layer of an adhesive resin or an adhesive which allows a layer containing the cyclic polyolefin and other layer to be bonded with each other, or allows the other types of layers to be bonded with each other.

The cyclic polyolefin in the present invention is a thermoplastic saturated norbornene polymer which is known (for example, as disclosed in JP-A 4-276253, JP-A 5-317411 and JP-A 8-155007). As a specific example thereof, a polymer having a structural unit as represented by Chemical 1 and/or Chemical 2 can be included.

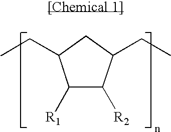

In the formula, R₁ and R₂ each represent a hydrogen atom or a hydrocarbon residue having from 1 to 10 carbon atoms, in which R₁ and R₂ may be the same or different and, further, R₁ and R₂ may form a ring with each other; and n represents a positive integer.

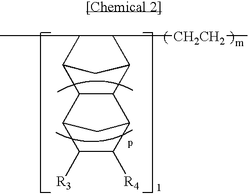

In the formula, R₃ and R₄ each represent a hydrogen atom or a hydrocarbon residue having from 1 to 5 carbon atoms, in which R₃ and R₄ may be the same or different and, further, R₃ and R₄ may form a ring with each other; 1 and m each represent a positive integer; and p represents 0 or a positive integer.)

The polymer having a structural unit as represented by Chemical 1 is a saturated polymer which is produced from an open-ring polymer such that the open-ring polymer obtained by polymerizing a monomer in a ring-open polymerization method is hydrogenated by an ordinary hydrogenation method. Examples of such monomers include 2-norbornene and its derivatives substituted with an alkyl group and/or an alkylidene group such as 5-methyl-2-norbornene, 5,5-dimethyl-2-norbornene, 5-ethyl-2-norbornene, 5-butyl-2-norbornene and 5-ethylidene-2-norbornene; dicyclopentadiene, 2,3-dihydrodicyclopentadiene and derivatives thereof substituted with an alkyl group such as methyl, ethyl, propyl or butyl group; dimethanooctahydronaphthalene and substitution derivatives thereof each with an alkyl group and/or an alkylidene group such as 6-methyl-1,4:5,8-dimethano-1,4,4a,5,6,7,8,8a-octahydronaphthalene, 6-ethyl-1,4:5,8-dimethano-1,4,4a,5,6,7,8,8a-octahydronaphthalene and 6-ethylidene-1,4:5,8-dimethano-1,4,4a,5,6,7,8,8a-octahydronaphthalene; a trimer or a tetramer of cyclopentadiene such as 4,9:5,8-dimethano-3a,4,4a,5,8,8a,9,9a-octahydro-1H-benzoindene, 5,8-methano-3a,4,4a,5,8,8a,9,9a-octahydro-1H-benzoindene, 5,8-methano-1,4,4a,4b,5,8,8a,9b-octahydro-1H-fluorene and 4,11:5,10:6,9-trimethano-3a,4,4a,5,5a,6,9,9a,10,10a,11,11a-dodecahydro-1H-cyclopenta anthracene.

Further, the polymer having a structural unit as represented by Chemical 2 is a polymer obtained by copolymerizing a norbornene type monomer as described above as a monomer and ethylene by using a known method and/or a hydrogenated article thereof and either one is a saturated polymer.

The cyclic polyolefin in the invention may be any one of the thermoplastic saturated norbornene type polymers which is a hydrogenated article of an open-ring polymer of a polar monomer, a copolymer of the norbornene type monomer and ethylene and the hydrogenated article of the copolymer.

In the present invention, a thermoplastic saturated norbornene type polymer of only monomers free from polar groups is preferable from the standpoint of impermeability of moisture. However, a polymer partially copolymerized with a polar monomer within a range which does not impair obtaining of the object of the invention is permissible.

As for polymers which each can be blended with the cyclic polyolefin, other polymers such as low-density polyethylene, straight-chain low-density polyethylene, medium-density polyethylene, high-density polyethylene, polypropylene, an ethylene/propylene copolymer and a styrene type elastomer are included. A blend ratio of any one of the other polymers is ordinarily cyclic polyofefin:other polymer=50 to 99:50 to 1 (in terms of weight ratio).

A layer formed by the cyclic olefin or a polymer blend thereof has a thickness of, ordinarily, 3 to 5000 μm and, preferably, 5 to 2000 μm and, when it is used as the multi-layered medical plural chamber container, the thickness is, ordinarily, 10 to 500 μm and, preferably, 20 to 300 μm.

As for a linear polyolefin layer adhered to the cyclic polyolefin layer, linear polyolefins, for example, low-density polyethylene, straight-chain low-density polyethylene, medium-density polyethylene, high-density polyethylene, polypropylene and an ethylene/propylene copolymer and an ethylene-vinyl acetate copolymer are included. As for polyamide layers, layers of nylon 6, nylon 66, nylon 12, nylon 612 and mixtures thereof are included.

In the present invention, a layer containing the linear polyolefin or the polyamide is positioned adjacent to and is adhered to a layer comprising the cyclic polyolefin or the polymer blend containing the cyclic polyolefin. Specifically, a film of these layers can be produced by using a dry lamination method, an extrusion coating method, a coextrusion lamination method (T-die method, inflation method), a heat lamination method or a lamination method in combination thereof. Particularly, the coextrusion lamination method is preferred. The coextrusion lamination method is performed by applying, for example, the T-die method, a multi-layered air-cooled inflation method or a multi-layered water-cooled inflation method.

The linear polyolefin or polyamide layer has a thickness of, ordinarily, 10 to 500 μm and, preferably, 20 to 300 μm.

In the present invention, there further exists a gas barrier layer and/or printable layer on the layer containing the linear polyolefin or polyamide.

In the present invention, the gas barrier layer is, specifically, a metal foil, a metal deposited layer or an inorganic-material deposited layer. Examples of such metal foil layers include an aluminum foil. Examples of such metal deposited layers include an alumina deposited polyester film and nylon film. Examples of such inorganic-material deposited layers include a silica deposited polyester film. Thickness of the gas barrier layer is, ordinarily, 5 to 50 μm.

Further, examples of such printable layers include a polyester layer of, for example, polyethylene terephthalate and that deposited thereon with an inorganic material such as silica. Thickness of the printable layer is, ordinarily, 5 to 50 μm.

As for one embodiment of the multi-layered film in the present invention, (i) a layer comprising a cyclic polyolefin or a polymer blend containing the cyclic polyolefin, (ii) a layer, which is adhered to the layer (i), comprising a linear polyolefin or a polyamide, (iii) a polyester layer or the polyester layer comprising an inorganic-material deposited thin film and (iv) a linear polyolefin layer are laminated in this order. It is desirable that the (ii) layer comprising the linear polyolefin or the polyamide, the (iii) polyester layer and the (iv) linear polyolefin layer are laminated with an adhesion layer being interposed between any two adjacent layers.

As for another embodiment of the multi-layered film in the present invention, (i) a layer comprising a cyclic polyolefin or a polymer blend containing the cyclic polyolefin, (ii) a layer, which is adhered to the layer (i), comprising a linear polyolefin or a polyamide, (v) a metal foil, a metal deposited layer or an inorganic-material deposited layer and (vi) a polyester layer are laminated in this order. It is desirable that the (ii) layer comprising the linear polyolefin or the polyamide, the (v) metal foil, metal deposited layer or inorganic-material deposited layer and the (vi) polyester layer are laminated with an adhesion layer being interposed between any two adjacent layers.

As for the production method for the multi-layered film, there may be used a method for laminating these layers by a dry lamination method, an extrusion coating method, a coextrusion lamination (T-die method, inflation method), a heat lamination method or a lamination method or combination of these methods. Other than these methods, a method in which the thermoplastic saturated norbornene type polymer is dissolved in a good solvent, namely, a heterocyclic hydrocarbon type solvent (cyclopentene, cyclohexane, methyl cyclohexane decalin or the like), an aromatic hydrocarbon type solvent (toluene, xylene, ethyl benzene or the like), a chlorinated hydrocarbon type solvent (chloroform, chlorobenzene or the like), mixed solvents thereof or solvents in which these solvents are mixed with other solvents and the resultant solution is applied and, then, dried can be adopted.

Further, lamination may be performed by using an adhesion or an adhesion resin between layers. As for such adhesions, a polyurethane type adhesion is mentioned. As for such adhesion resins, a vinyl acetate copolymer emulsion type, a solution type of a synthetic rubber (chloroprene, SBR, butyl rubber or the like), a solution type of polyolefin which has been chlorinated or denatured by maleic anhydride and the like can be mentioned.

Thickness of the adhesion layer is appropriately selected depending on types, thickness or the like of the films to be bonded.

As for methods for producing the multi-layered container, various types of methods such as a sheet forming method (heat forming method) such as a vacuum forming method, a pneumatic forming method, a blow forming method such as a multi-layered coextrusion blow forming and a method in which peripheral portions of multi-layered films which have each been cut in a predetermined shape are heat-sealed or bonded with each other with an adhesion to produce a bag-shape article can be adopted.

The multi-layered medical container in the present invention is characterized in that the multi-layered films are bonded with each other such that the innermost layers are each a layer comprising the cyclic polyolefin or the polymer blend containing the cyclic polyolefin.

The low molecular weight component and the adhesion layer component eluted from the multi-layered container can be reduced by allowing the innermost layer to be a layer comprising the cyclic polyolefin or the polymer blend containing the cyclic polyolefin. The cyclic polyolefin has a higher density than the low density polyethylene and has a three-dimensional structure, so that the molecular mobility of the cyclic polyolefin is suppressed more than that of the linear polyolefin. Laminating the cyclic polyolefin film with the linear polyolefin film results in tempering of the hardness that is an actual characteristic of the cyclic polyolefin and providing a smooth surface of the laminated film. Further, the multi-layered container in the present invention can have rigidity of the bag and printability owing to the polyester layer and, still further, is imparted with a barrier property against steam or a gas owing to the metal foil, the metal deposited layer or the inorganic-material deposited layer and, accordingly, is capable of containing a medicament which is unstable against moisture and gas such as oxygen.

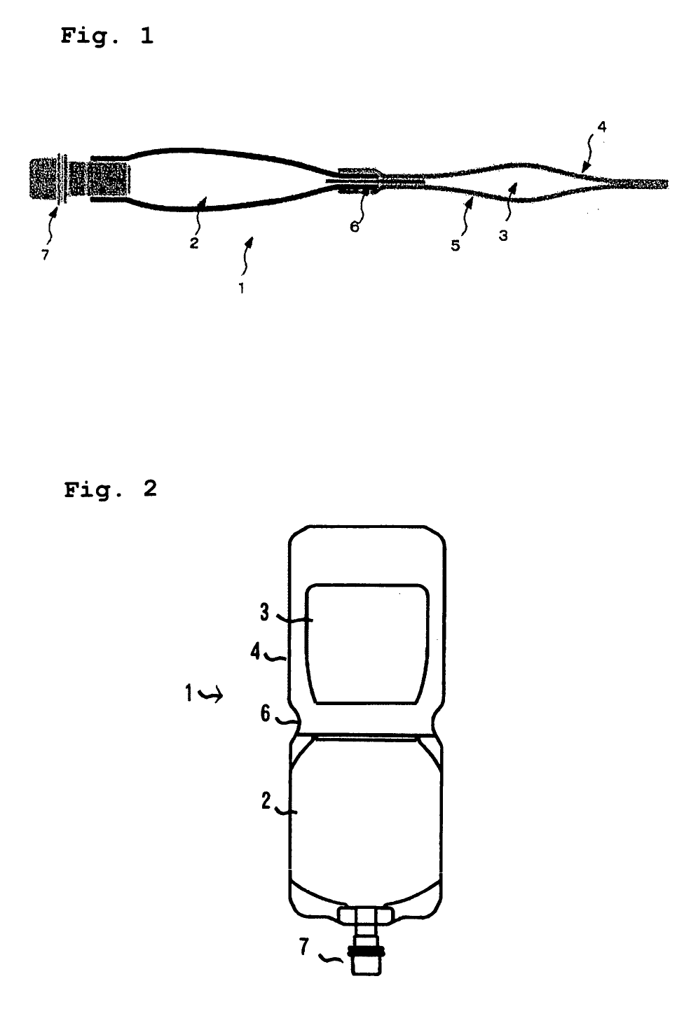

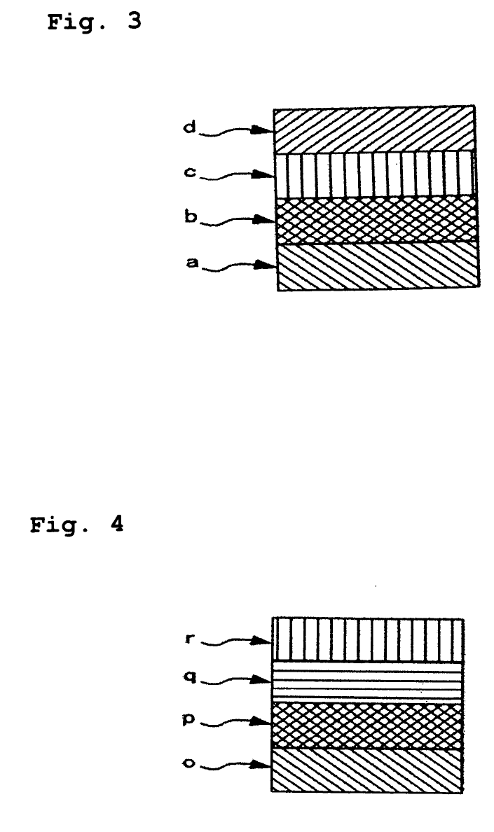

As for one embodiment of the multi-layered medical plural chamber container in the present invention, there is a bag-shape article which is divided by a peelable seal portion into a medical liquid-containing chamber that stores a medical liquid and a medicament-containing chamber that stores a medicament in a fluid-tight manner. The medicament-containing chamber is a bag-shape article constituted by a front sheet and a rear sheet, while the medical liquid-containing chamber is a bag-shape article formed by a tubular film. One embodiment of a plural chamber container of the present invention is shown in FIGS. 1 and 2. In FIGS. 1 and 2, the reference numeral 1 denotes a plural chamber container; the reference numeral 2 denotes a medical liquid-containing chamber; the reference numeral 3 denotes a medicament-containing chamber; the reference numeral 4 denotes a front sheet; the reference numeral 5 denotes a rear sheet; the reference numeral 6 denotes a weak seal portion; and the reference numeral 7 denotes a medicament leading-out portion. One embodiment of the multi-layered film constituting the container in the present invention is shown in FIGS. 3 and 4. In FIG. 3, the reference sign (a) denotes a layer (innermost layer) comprising a cyclic polyolefin or a polymer blend containing the cyclic polyolefin; the reference sign (b) denotes a layer (intermediate layer) comprising a linear polyolefin or a polyamide; the reference sign (c) denotes a polyester layer or a polyester layer (intermediate layer) comprising an inorganic-material deposited thin film; and the reference sign (d) denotes a linear polyolefin layer (outermost layer). In FIG. 4, the reference sign (O) denotes a layer (innermost layer) comprising a cyclic polyolefin or a polymer blend containing the cyclic polyolefin; the reference sign (p) denotes a layer (intermediate layer) comprising a linear polyolefin or a polyamide; the reference sign (q) denotes a metal foil, a metal deposited layer or an inorganic-material deposited layer (intermediate layer); and the reference sign (r) denotes a polyester layer (outermost layer).

The front sheet of the medicament-containing chamber is constituted by a multi-layered film in which (i) a layer (innermost layer) comprising a cyclic polyolefin or a polymer blend containing the cyclic polyolefin, (ii) a layer (intermediate layer), which is adhered to the layer as described in (i), comprising a linear polyolefin or a polyamide, (iii) a polyester layer or a polyester layer (intermediate layer) comprising an inorganic-material deposited thin film and (iv) a linear polyolefin layer (outermost layer) are laminated in this order (FIG. 3). Further, the rear sheet of the medicament-containing chamber is constituted by a multi-layered film in which (i) a layer (innermost layer) comprising a cyclic polyolefin or a polymer blend containing the cyclic polyolefin, (ii) a layer (intermediate layer), which is adhered to the layer as described in (i), comprising a linear polyolefin or a polyamide, (v) a metal foil, a metal deposited layer or an inorganic-material deposited layer (another intermediate layer) and (vi) a polyester layer (outermost layer) are laminated in this order (FIG. 4).

In another embodiment in the present invention, the front sheet of the medicament-containing chamber may be constituted by a multi-layered film in which (i) a layer (innermost layer) comprising a cyclic polyolefin or a polymer blend containing the cyclic polyolefin, (ii) a layer (intermediate layer), which is adhered to the layer as described in (i), comprising a linear polyolefin or a polyamide, (iii) a polyester layer or a polyester layer (another intermediate layer) comprising an inorganic-material deposited thin film and (iv) a linear polyolefin layer (outermost layer) are laminated in this order (FIG. 3) and, further, the rear sheet of the medicament-containing chamber may be constituted by a multi-layered film (not shown) in which a linear polyolefin layer (innermost layer), a metal foil, a metal deposited layer or an inorganic-material deposited layer (intermediate layer) and a polyester layer (outermost layer) are laminated in the stated order.

In still another embodiment in the present invention, the rear sheet of the medicament-containing chamber may be constituted by a multi-layered film in which (i) a layer (innermost layer) comprising a cyclic polyolefin or a polymer blend containing the cyclic polyolefin, (ii) a layer (intermediate layer), which is adhered to the layer as described in (i), comprising a linear polyolefin or a polyamide, (v) a metal foil, a metal deposited layer or an inorganic-material deposited layer (another intermediate layer) and (vi) a polyester layer (outermost layer) are laminated in order (FIG. 4) and, further, the front sheet of the medicament-containing chamber may be constituted by a multi-layered film (not shown) in which a linear polyolefin layer (innermost layer), a polyester layer or the polyester layer (intermediate layer) comprising an inorganic-material deposited thin film and a linear polyolefin layer (outermost layer) are laminated in the stated order.

It is desirable that the medical liquid-containing chamber is constituted by a monolayer or a multi-layered film containing a polyolefin type resin and is a bag-shape article having two sheets of films or a tubular film. As for such polyolefin type resins, low-density polyethylene, straight-chain low-density polyethylene, medium-density polyethylene, high-density polyethylene, polypropylene, an ethylene/propylene copolymer and blending thereof are mentioned.

The medical liquid-containing chamber that stores the medical liquid and the medicament-containing chamber that stores the medicament are divided by a peelable seal portion in a fluid-tight manner.

The peelable seal portion is a member having an easy-peel function and a portion in which innermost layers forming the medicament-containing chamber and/or the medical liquid-containing chamber are thermally bonded with each other or a portion in which a separate member formed by a linear polyolefin film and/or a cyclic polyolefin film and a resin film which adheres weakly to a linear polyolefin film and/or a cyclic polyolefin film and an innermost layer forming the medicament-containing chamber and/or the medical liquid-containing chamber are thermally bonded with each other. As for such separate members, for example, a blend polymer containing polyethylene and polypropylene, an ethylene/propylene copolymer, or a blend (JP-A No. 2001-226499) of a propylene/α-olefin copolymer (A) and another propylene/α-olefin copolymer (B) which has a different α-olefin content from the copolymer (A) and/or a propylene homopolymer can be mentioned.

As for the medical liquids, water for injection, a normal saline solution, a glucose solution, an amino acid solution, a high-calorie infusion, a fat emulsion preparation, a vitamin preparation, a metallic element preparation and the like can be included. Further, the medicament is a solid or liquid-state medicament and an antibiotic, an antibacterial agent, an anti-tumor agent, a hormone preparation, Chinese herbal medicine and the like can be included. Particularly, it is desirable to contain a solid medicament, for example, that which is in a powder state, which is more unstable in storage than the medical liquid.

### EXAMPLES

Next, the present invention will be described in further detail with reference to Examples and Comparative Examples.

In the Examples and Comparative Examples, turbidity is measured in accordance with a method as described below.

Turbidity: an amount of transmitted light (parallel light ray from an LED light source) attenuated by a turbidity material and a scattered light amount (measured by a light-receiving portion placed in a direction of 90° from a light source) caused by the turbidity material were simultaneously measured by using a turbidimeter (2100N, available from HACH), to thereby obtain a ratio therebetween. As a turbidity measurement unit, a formadine turbidity (NTU) is adopted.

### Example 1

Cyclic polyolefin (trade name: Zeonor; available from Zeon Corporation, COP) was extruded together with medium density polyethylene (density: 0.938, MDPE) at 250° C. by using a coextruder, to thereby form a 2-layer film (former: 30 μm; latter: 20 μm). On the medium density polyethylene layer of the thus-formed 2-layer film, a polyethylene terephthalate film (thickness: 12 μm; available from Mitsubishi Chemical, PET) and a medium density polyethylene film (density: 0.938; thickness: 40 μm, MDPE) were laminated in this order via a polyolefin type adhesion resin (LLDPE), to thereby prepare a multi-layered film (front sheet A). Thickness of the adhesion resin (LLDPE) was 20 μm.

Next, the cyclic polyolefin (trade name: Zeonor; available from Zeon Corporation, COP) was extruded together with medium density polyethylene (density: 0.938, MDPE) at 250° C. by using a coextruder, to thereby form a 2-layer film (former: 30 μm; latter: 20 μm). Separately, an aluminum foil (thickness: 20 μm; available from Sun Alumi, Al) and a polyethylene terephthalate film (thickness: 16 μm; available from Toyobo Co., Ltd. PET) were laminated by using a polyurethane type adhesion (Takeda Pharmaceutical Co., Ltd.), to thereby obtain a 2-layer laminate. On the medium density polyethylene layer of the 2-layer film, the aluminum foil of the 2-layer laminate was laminated via a polyolefin type adhesion resin (LLDPE), to thereby produce a multi-layered film (rear sheet B). Thickness of the adhesion layer (LLDPE) was 20 μm.

Three-way peripheral portions of the multi-layered film (A) and the multi-layered film (B) were strongly sealed with each other by using a heat sealer at 170° C. under 0.3 MPa while allowing the cyclic polyolefin layers to be the innermost layers, to thereby prepare a bag-shape container (140 mm×115 mm).

Powder-state antibiotic (a) (1.0 g) was filled in the bag-shape container and the bag was sealed by heat, to thereby prepare a sample. After the sample was stored for one month at 50° C., 20 g of the powder-state solid antibiotic was taken out of the bag-shape container, dissolved in water (50 ml) and turbidity (NTU) of the resultant solution was measured by using a turbidimeter (2100N; available from HACH). The results are shown in Table 1.

### Comparative Example 1

A container was produced in a same manner as in Example 1 except that the cyclic polyolefin layers of the innermost layers of the multi-layered film (A) and the multi-layered film (B) were changed into straight-chain low density polyethylene (LLDPE) layers. Namely, the cyclic polyolefin (trade name: Zeonor; available from Zeon Corporation, COP) was coextruded together with straight-chain low density polyethylene (density: 0.930) at 250° C. by using a coextruder, to thereby form a 2-layer film (former: 30 μm; latter: 20 μm). On the cyclic polyolefin layer of the 2-layer film, a polyethylene terephthalate film (thickness: 12 μm; available from Mitsubishi Chemical, PET) and a straight-chain low density polyethylene (density: 0.930; thickness: 20 μm) were laminated in this order via a polyolefin type adhesion resin (LLDPE), to thereby produce a multi-layered film (front sheet C). Thickness of the adhesion resin was 20 μm.

Next, the cyclic polyolefin (trade name: Zeonor; available from Zeon Corporation) was coextruded together with straight-chain low density polyethylene (density: 0.930) at 250° C. by using a coextruder, to thereby form a 2-layer film (former: 30 μm; latter: 20 μm). An aluminum foil (thickness: 20 μm; available from Sun Alumi, Al) and a polyethylene terephthalate film (thickness: 16 μm; available from Toyobo Co., Ltd. PET) were laminated by using a polyurethane type adhesion (Takeda Pharmaceutical Co., Ltd.), to thereby obtain a 2-layer laminate. On the cyclic polyolefin layer of the 2-layer film, the aluminum foil of the 2-layer laminate was laminated via a polyolefin type adhesion resin (Japan Polyethylene Corporation), to thereby produce a multi-layered film (rear sheet D). Thickness of the adhesion layer was 20 μm.

Three-way peripheral portions of the multi-layered film (C) and the multi-layered film (D) were strongly sealed with each other by using a heat sealer at 165° C. under 0.3 MPa while allowing the medium density polyethylene layers to be the innermost layers, to thereby prepare a bag-shape container (140 mm×115 mm).

In the same manner as in Example 1, after the sample was stored in the bag-shape container for one month at 50° C., turbidity (NTU) was measured. The results are shown in Table 1.

### Comparative Example 2

A high density polyethylene film (density: 0.957; thickness: 60 μm, HDPE), a silica deposited polyethylene terephthalate film layer (thickness: 12 μm; available from Mitsubishi Chemical, SiPET), a polyethylene terephthalate film layer (thickness: 12 μm; available from Mitsubishi Chemical, PET) and a high density polyethylene film (density: 0.957; thickness: 40 μm, HDPE) were laminated in this order via a polyurethane type adhesion, to thereby produce a multi-layered film (front sheet E). On the other hand, a multi-layered film (rear sheet F) was obtained from a high density polyethylene film (density: 0.957; thickness: 40 μm, HDPE), an aluminum foil (thickness: 20 μm; available from Sun Alumi, Al) and a polyethylene terephthalate film (thickness: 16 μm; Toyobo Co., Ltd. PET) by using polyurethane type adhesion A520/A50 (Takeda Pharmaceutical Co., Ltd.). Three-way peripheral portions of the multi-layered film (front sheet G) and the multi-layered film (rear sheet H) were strongly sealed with each other by using a heat sealer at 170° C. under 0.3 MPa while allowing the high density polyethylene layers to be the innermost layers, to thereby prepare a bag-shape container (140 mm×115 mm).

In the same manner as in Example 1, after the sample was stored in the bag-shape container for one month at 50° C., turbidity (NTU) was measured. The results are shown in Table 1.

### Comparative Example 3

Multi-layered films (front sheet G, rear sheet H) were produced by excluding the cyclic polyolefin (trade name: Zeonor; available from Zeon Corporation, COP) from those in Comparative Example 1 and, then, a bag-shape container was prepared in the same manner as in Comparative Example 1.

In the same manner as in Example 1, after the sample was stored in the bag-shape container for one month at 50° C., turbidity (NTU) was measured. The results are shown in Table 1.

### Comparative Example 4

Multi-layered films (front sheet I, rear sheet J) were produced by using a straight-chain low density polyethylene film (density: 0.930; thickness: 60 μm, LLDPE) in place of the high density polyethylene film in Comparative Example 2 and, then, a bag-shape container was prepared in the same manner as in Comparative Example 2.

In the same manner as in Example 1, after the sample was stored in'the bag-shape container for one month at 50° C., turbidity (NTU) was measured. The results are shown in Table 1.

TABLE 1

| | | | Turbidity |
|---|---|---|---|
| | Front sheet | Rear Sheet | (NTU) |
| Example 1 | (A) COP/MDPE/ | (B) | 1.33 |
| | PET/MDPE | COP/MDPE/Al/PET | |
| Comparative | (C) LLDPE/COP/ | (D) | 2.15 |
| Example 1 | PET/LLDPE | LLDPE/COP/Al/PET | |
| Comparative | (E) HDPE/SiPET/ | (F) HDPE/Al/PET | 2.43 |
| Example 2 | PET/HDPE | | |
| Comparative | (G) LLDPE/PET/ | (H) LLDPE/Al/PET | 4.52 |
| Example 3 | LLDPE | | |
| Comparative | (I) LLDPE/SiPET/ | (J) LLDPE/Al/PET | 8.91 |
| Example 4 | PET/LLDPE | | |

### Example 2

A tube-shape article (100 mm×150 mm) of a straight-chain low density polyethylene (0.923; thickness: 250 μm) was produced. At a distal end thereof, a medicament discharge port was provided. The resultant tube-shape article was strongly bonded for 3.0 seconds at 145° C. and, then, a small chip made of a blend polymer containing polyethylene and polypropylene was inserted into the distal end thereof. The resultant tube-shape article was weakly bonded for 3.5 seconds at 150° C., to thereby form a medical liquid-containing chamber. After this medical liquid-containing chamber was formed, the chamber was filled with a solution and, then, subjected to a steam sterilization. Further, the medicament-containing chamber prepared in Example 1 was subjected to γ-ray sterilization as it is in a bag-shape article (140 mm×115 mm) and, then, was aseptically filled with a solid medicine preparation. Thereafter, the innermost layer of the remaining one-way end of the bag-shape article which had been strongly bonded at 3-way ends and the outermost layer of the medical liquid—containing chamber were strongly bonded with each other for 4.0 seconds at 150° C. via the small chip, to thereby produce the multi-layered medical plural chamber container having the medicament-containing chamber and the medical liquid-containing chamber (FIG. 1).

### Example 3 and Comparative Examples 5-8

Powder-state antibiotics (b)-(f) were filled in separate bag-shape containers as prepared in Example 1 and Comparative Examples 1-4, in the same manner as Example 1 and were stored in the bag-shape containers for one month at 50° C. Turbidity (NTU) of the samples was evaluated in the same manner as Example 1. The results are shown in Table 2.

TABLE 2

| | antibiotic | | antibiotic | | antibiotic | | antibiotic | | antibiotic | |
|---|---|---|---|---|---|---|---|---|---|---|
| | (b) | | (c) | | (d) | | (e) | | (f) | |
| | time | | | | | | | | | |
| | 0 T | 1 M | 0 T | 1 M | 0 T | 1 M | 0 T | 1 M | 0 T | 1 M |
| Ex. 3 | 0.93 | 0.92 | 0.80 | 0.65 | 1.60 | 1.25 | 2.85 | 2.32 | 3.81 | 3.83 |
| Comp. 5 | 0.82 | 1.07 | 0.72 | 1.34 | 1.68 | 2.12 | 2.09 | 5.20 | 3.75 | 4.83 |
| Comp. 6 | 0.91 | 1.11 | 1.21 | 1.35 | 1.88 | 4.75 | 3.00 | 5.50 | 3.80 | 4.95 |
| Comp. 7 | 0.98 | 1.22 | 1.15 | 1.83 | 2.56 | 5.81 | 3.65 | 7.15 | 4.21 | 5.66 |
| Comp. 8 | 1.02 | 1.51 | 1.86 | 2.57 | 5.07 | 8.47 | 4.45 | 9.17 | 4.96 | 6.37 |

0 T: immediately after storing the medicament in the container
1 M: one month after storing the medicament in the container

This application claims priority of Japanese patent application No. 2004-236395 filed Aug. 16, 2004, which is incorporated herein by reference.

What is claimed is:

1. A multi-layered medical container comprising a body for storing a medicament and a port provided in the body, wherein the body is formed by a multi-layered film having a first layer comprising a cyclic polyolefin or a polymer blend containing the cyclic polyolefin and a second layer, adhered to the first layer, comprising a linear polyolefin or a polyamide.

2. The multi-layered medical container according to claim 1, wherein the multi-layered film further comprises a gas barrier layer and/or a printable layer on the second layer.

3. The multi-layered medical container according to claim 2, wherein the gas barrier layer is a metal foil, a metal deposited layer or an inorganic-material deposited layer.

4. The medical container according to claim 2, wherein the printable layer is a polyester layer.

5. The multi-layered medical container according to claim 1, wherein the multi-layered film is formed by laminating in order (i) a layer comprising a cyclic polyolefin or a polymer blend containing the cyclic polyolefin, (ii) a layer, which is adhered to layer (i), comprising a linear polyolefin or a polyamide, (iii) a polyester layer or a polyester layer having an inorganic-material deposited thin film and (iv) a linear polyolefin layer.

6. The multi-layered medical container according to claim 5, wherein the layer (ii) comprising the linear polyolefin or the polyamide, the (iii) polyester layer or the polyester layer having the inorganic-material deposited thin film and the linear polyolefin layer (iv) are laminated with an adhesion layer being interposed between any two adjacent layers.

7. The multi-layered medical container according to claim 1, wherein the multi-layered film is formed by laminating in order (i) a layer comprising a cyclic polyolefin or a polymer blend containing the cyclic polyolefin, (ii) a layer, which is adhered to the layer (i), comprising a linear polyolefin or a polyamide, (v) a metal foil, a metal deposited layer or an inorganic-material deposited layer and (vi) a polyester layer.

8. The multi-layered medical container according to claim 7, wherein the layer (ii) comprising the linear polyolefin or the polyamide, the metal foil, the metal deposited layer or the inorganic-material deposited layer (v) and the polyester layer (vi) are laminated with an adhesion layer being interposed between any two adjacent layers.

9. A multi-layered medical container, comprising a body for storing a medicament and a discharge port provided in the body and prepared by bonding two multi-layered films according to claim 5 with each other such that an innermost layer comprises the cyclic polyolefin or a polymer blend comprising the cyclic polyolefin.

10. The multi-layered medical container comprising a body for storing a medicament and a discharge port provided in the body, wherein the body is prepared by bonding two multi-layered films according to claim 7 with each other such that an innermost layer comprises the cyclic polyolefin or a polymer blend comprising the cyclic polyolefin.

11. The multi-layered medical container comprising a body for storing a medicament and a discharge port provided in the body, wherein the body is prepared by bonding to each other the multi-layered film according to claim 5 and a multi-layered film formed by laminating in order (i) a layer comprising a cyclic polyolefin or a polymer blend containing the cyclic polyolefin, (ii) a layer, which is adhered to the layer (i), comprising a linear polyolefin or a polyamide, (v) a metal foil, a metal deposited layer or an inorganic-material deposited layer and (vi) a polyester layer such that an innermost layer comprises the cyclic polyolefin or a polymer blend comprising the cyclic polyolefin.

12. The multi-layered medical container according to claim 1, wherein the medicament is a solid medicament.

13. The multi-layered medical container according to claim 1, wherein the medicament is a solid medicament selected from the group consisting of an antibiotic, an antibacterial agent, an antitumor agent and a hormone preparation.

14. A multi-layered medical plural chamber container comprising a body and a discharge port provided in the body, the body being divided into a medical liquid-containing chamber for storing a medical liquid and a medicament-containing chamber for storing a medicament by a peelable seal portion in a fluid-tight manner,
wherein the medicament-containing chamber is a bag-shape article constituted by a front sheet and a rear sheet
and wherein the front sheet of the medicament-containing chamber is constituted by a multi-layered film having a first layer comprising a cyclic polyolefin or a polymer blend containing the cyclic polyolefin and a second layer, adhered to the first layer, comprising a linear polyolefin or a polyamide.

15. The multi-layered medical plural chamber container according to claim 14, wherein the front sheet of the medicament-containing chamber is constituted by a multi-layered film in which (i) an innermost layer comprising a cyclic polyolefin or a polymer blend containing the cyclic polyolefin, (ii) an intermediate layer, which is adhered to layer (i), comprising a linear polyolefin or a polyamide, (iii) a second intermediate layer which is a polyester layer or a polyester layer comprising an inorganic-material deposited thin film and (iv) an outermost layer of a linear polyolefin are laminated in this order.

16. The multi-layered medical plural chamber container according to claim 14, wherein the rear sheet of the medicament-containing chamber is constituted by a multi-layered film in which (i) an innermost layer comprising a cyclic polyolefin or a polymer blend containing the cyclic polyolefin, (ii) an intermediate layer, which is adhered to the layer (i), comprising a linear polyolefin or a polyamide, (v) as a second intermediate layer, a metal foil, a metal deposited layer or an inorganic-material deposited layer and (vi) an outermost layer of a polyester are laminated in this order.

17. The multi-layered medical plural chamber container according to claim 14, wherein the front sheet of the medicament-containing chamber is constituted by a multi-layered film in which (i) an innermost layer comprising a cyclic polyolefin or a polymer blend containing the cyclic polyolefin, (ii) an intermediate layer, which is adhered to layer (i), comprising a linear polyolefin or a polyamide, (iii) a second intermediate layer which is a polyester layer or a polyester layer comprising an inorganic-material deposited thin film and (iv) an outermost layer of a linear polyolefin are laminated in this order and the rear sheet of the medicament-containing chamber is constituted by a multi-layered film in which (i) an innermost layer comprising a cyclic polyolefin or a polymer blend containing the cyclic polyolefin, (ii) an intermediate layer, which is adhered to the layer (i), comprising a linear polyolefin or a polyamide, (v) as a second intermediate layer, a metal foil, a metal deposited layer or an inorganic-material deposited layer and (vi) an outermost layer of a polyester are laminated in this order.

18. The multi-layered medical plural chamber container according to claim 14, wherein the front sheet of the medicament-containing chamber is constituted by a multi-layered film in which (i) an innermost layer comprising a cyclic polyolefin or a polymer blend containing the cyclic polyolefin, (ii) a first intermediate layer, which is adhered to layer (i), comprising a linear polyolefin or a polyamide, (iii) a second intermediate layer which is a polyester layer or a polyester layer comprising an inorganic-material deposited thin film and (iv) an outermost layer of a linear polyolefin are laminated in this order and the rear sheet of the medicament-containing chamber is constituted by a multi-layered film in which an innermost layer of a linear polyolefin; an intermediate layer of a metal foil, a metal deposited layer or an inorganic-material deposited layer and an outermost layer of a polyester are laminated in the stated order.

19. The multilayered medical plural chamber according to claim 14, wherein the rear sheet of the medicament-containing chamber is constituted by a multi-layered film in which (i) an innermost layer comprising a cyclic polyolefin or a polymer blend containing the cyclic polyolefin, (ii) a first intermediate layer, which is adhered to layer (i), comprising a linear polyolefin or a polyamide, (v) a second intermediate layer of a metal foil, a metal deposited layer or an inorganic-material deposited layer and (vi) an outermost layer of a polyester are laminated in order and the front sheet of the medicament-containing chamber is constituted by a multi-layered film in which an innermost layer of a linear polyolefin; an intermediate layer of a polyester or a polyester layer comprising an inorganic-material deposited thin film; and an outermost layer of a linear polyolefin are laminated in the stated order.

20. The multi-layered medical plural chamber container according to claim 14, wherein the medical liquid-containing chamber is a tubular article constituted by a monolayer film or a multi-layered film comprising a linear polyolefin.

21. The multi-layered medical plural chamber container according to claim 14, wherein the peelable seal portion is a portion in which innermost layers forming the medicament-containing chamber and/or the medical liquid-containing chamber are bonded with each other or is a portion in which a separate member formed by a resin film which adheres weakly to a linear polyolefin film and/or a cyclic polyolefin film and an innermost layer forming the medicament-containing chamber and/or the medical liquid-containing chamber are bonded with each other.

22. The multi-layered medical container according to claim 14, wherein the medicament is a solid medicament.

23. The multi-layered medical container according to claim 14, wherein the medicament is a solid medicament selected from the group consisting of an antibiotic, an antibacterial agent, an anti-tumor agent and a hormone preparation.

24. The multi-layered medical container according to claim 14, wherein the medical liquid is water for injection, a normal saline solution, a glucose liquid, an amino acid liquid, a high-calorie infusion, a fat emulsion preparation, a vitamin preparation or a metallic element preparation.
